(19) United States
(12) Patent Application Publication
(10) Pub. No.: US 2017/0190600 A1
(43) Pub. Date: Jul. 6, 2017

(54) CHEMICAL TREATMENT PROCESS OF SEWAGE WATER

(71) Applicant: BLUETEAK INNOVATIONS, LLC, NOVI, MI (US)

(72) Inventors: Chinna VENKATESHWAR, NOVI, MI (US); Samuel MATHEW THEKKINAPATHALIL, NOVI, MI (US)

(21) Appl. No.: 15/393,833

(22) Filed: Dec. 29, 2016

Related U.S. Application Data
(60) Provisional application No. 62/272,981, filed on Dec. 30, 2015.

(51) Int. Cl. C02F 1/52; C02F 11/04; B01D 53/78; C02F 1/66

(52) U.S. Cl. CPC C02F 1/5245; C02F 1/5236; C02F 1/66; C02F 11/04; B01D 53/78; C02F 2101/20

(57) ABSTRACT

A process for the treatment of sewage water to contaminant free water is done by two steps of basification or acidification followed by neutralization. Basification occurs by adding basic chemicals to sewage water up to 12 P^{H} followed by adding acidic chemicals up to 7 P^{H} for neutralization. Similarly acidification occurs by adding acidic chemicals up to 4 P^{H} followed by adding basic chemicals up to 7 P^{H}. The sludge formed during basification and acidification is separated from two steps of treated sewage water. For better results basification is extended up to acidification P^{H} followed by adding of acidic chemicals up to 7 P^{H}, similarly acidification is extended up to basification followed by adding of basic chemicals up to 7 P^{H}. Gases generated in the whole process can be absorbed by ferrous chloride and/or calcium chloride added to the acidification and basification reactions.

### CROSS-REFERENCE TO RELATED APPLICATIONS

The present invention claims priority to U.S. Provisional Application No. 62/272,981, filed Dec. 30, 2015. The entire subject matter of this provisional application document is incorporated by reference herein.

### BACKGROUND OF THE INVENTION

Urbanization of the world has generated major water pollution of domestic sewage water. Sewage waste water contains more carbon and nitrogen compared to the industrial wastewater due to the high amount of organic matter, for example, nitrogen from ammonia, free nitrogen or saline ammonia, and nitrogen derived from proteinaceous matters contained in sewage water. The ammonia nitrogen constitutes about 50%-70% of the total nitrogen. Domestic sewage water contains large amounts of urine, which contains about 2.5% urea, 1% sodium chloride and other complex organic substances. Inorganic substances such as nitrates and phosphates of detergents and further synthetic detergents surface active agents containing Na⁺, K⁺, Ca₂⁺², Cl⁻, HCO₃, also contribute phosphates of sodium and other builders. Biodegradable feces, animal waste and household wastes comprise organic compositions such as fats, carbohydrates, and proteins. Additionally, heavy metals such, Cu, Cr, Zn, Mn, Pb and Ni are present in sewage. Saprophytic, pathogenic, and facultative bacteria, viruses, protozoa, fungal and algae multiply in domestic sewage water and are harmful and dangerous because pathogenic organisms remain in the sewage even after conventional treatment and thereby contaminate the receiving river, lake, pond or reservoir.

Known sewage treatment methods typically utilize anaerobic decomposition. Fresh sewage contains 2 to 5 ppm of oxygen hence the aerobic bacteria utilize it and react on organic matter. Due to lack of oxygen, the anaerobic bacteria start their activity with the little amount of oxygen available in the complex organic matter and the decomposition takes place in a number of stages but the principal end products of decomposition of carbonaceous and nitrogenous matter (proteins) are CO₂, CH₄, organic acids, NH₃, amino acids, amides, indole and skatole. Sulfur chemicals are decomposed into H₂S, and mercaptans, which emit unpleasant odors. The water produced in the reaction is filtered and chlorinated for disinfection, and then the water is released into streams or other waterways.

For faster treatment of the sewage, aerobic decomposition is used instead of anaerobic decomposition. Oxygen may also be obtained easily from the decomposition of nitrates and nitrites. The oxygen availability is achieved by allowing the sewage to trickle through the process using trickling filters and blowing air through a mixture of previously activated sludge accompanied by strong agitation. Both of these processes may be used in combination as an activated sludge treatment method which requires an aeration tank, contact beds, intermittent sand fitters, trickling fitters, oxidation ponds and biological treatment. Further purification of waste water by advanced biological, chemical and physical processes is used for the recycling of water in tertiary treatment.

The main objective in sewage treatment is the breakdown of organic matter by bacterial action into simple substances that do not decompose further by bacteria after preparatory treatment. This is achieved by removal of various obstructing substances from liquid by using rocks, screens, skimming tanks and grit chambers for decomposition of organic matter which is below 1% in sewage, where the obstructing objects are removed in preparatory treatment then exposed for decomposition.

Typically, the organic load is reduced by primary treatment before aerobic decomposition to remove coarse suspended and floating matter by means of screening grit (sand, broken glass, metal, plastic, paper, and floating debris), and to remove grease and oil by floatation in skimming tanks. The suspended colloidal solids (finely divided negatively charged particles) are removed by adding one or more of aluminum sulfate, (also called alum or aluminum sulphate), chlorinated copper, ferric and ferrous sulfate, ferric chloride, sodium silicate, sulfur dioxide and lime, as coagulating agents. The flocs formed interconnect and grow bigger, and settle as flocculation when slowly agitated. Chemicals destroy the bacteria. This treatment method is costly and skilled supervision is required, making it a less desirable process. Aerobic bacteria decompose the complex matter into CO₂, NO₂, PO₃, SO₄, etc., in presence of free oxygen or dissolved oxygen provided by multiplication of algae in dirty sewage water. Phosphorus, sulfur, nitrogen, and potassium all contribute to the growth and development of algae.

Storm water drains, small rivulets, and small and big rivers which carry rain water have become carriage ways of domestic and industrial waste waters where treatment facilities are non-existent or of inadequate capacity. The various conventional treatment facilities being constructed and operated include: septic tanks, twin leech pits, stabilization ponds, aerated lagoons, activated sludge process (ASP), extended aeration process, and up flow anaerobic sludge blanket (UASB) followed by aerated lagoons. Stabilization ponds require vast lands due to long detention times i.e., from 10 to 15 days, so are not suitable for towns and cities. Aerated lagoons also require large areas due to detention time of 2 to 5 days. The activate sludge process requires less land when compared to the above two process as the detention time varies between 6 to 12 hours, but power consumption is high. The BOD Removal efficiency is up to 85% in this process hence being widely used for treatment of sewage in cities. The land requirement for this process is about 2000 Sq. Meters for 10 MLD (Million liters per day) Capacity Sewage Treatment Plant (STP). The extended aeration process is the best process available in conventional treatment with BOD removal efficiency up to 97% and this process is widely used for small capacity sewage treatment plants. The land requirement for this process is slightly less than ASP, the operation and maintenance costs are slightly higher due to a longer detention time of 12 to 21 hours, and power consumption is higher, but the effluent quality is excellent.

Conventional sewage treatment plants are large and very costly to run. The plants require large treatment areas and expensive technology and use a large amount of electricity. Most disconcerting is that treated sewage water being discharged into rivers, lakes and streams, contains heavy metals, algae, fungi, micro-organisms of pathogens, and nutrients like phosphorous, nitrogen, ammonia which lead to drinking water pollution. Conventional processes do not adequately remove dissolved solids. The energy consumption is very high and the expenditure on the treatment is not recovered. Treated water is often not adequately pure and disposal of sludge generated during treatment is problematic.

### SUMMARY OF THE INVENTION

A treatment process for sewage waters having different compositions for which there is no treatment process available, or the treatment of which is time-consuming and/or expensive, is provided by the present invention. The treatment process is useful for various types of sewage water including, but not limited to, normal domestic sewage water, soapy sewage water, metal-containing sewage water, sulfur-containing sewage water, ammonia containing sewage water, urine-containing sewage water, and mixed sewage water (domestic sewage water mixed with waste water). The listed sewage water is identified by the composition most prevalent therein.

The treatment process of the present invention includes a first preparatory step of removing solids from sewage waste by filtering through a screen or other process. Following this preparatory step the waste is subjected to a first chemical treatment which is an acidification process including treatment with acidic chemicals, and a basification process including treatment with basic chemicals. The acidification and basification process comprises two steps, each resulting in the formation of sludge which contains water and precipitated solids. The resultant sludge is filtered to separate treated water from solid precipitate. The filtered water is removed and subjected to subsequent treatment. Where the first step is basification, the basic water is neutralized with acidic chemicals. Where the first step is acidification, the acidic water is neutralized with basic chemicals.

Following the first treatment step, the sewage water is treated in a second treatment step. If the first treatment step is a basification step, the second step will be neutralization step. If the first treatment step is an acidification step, the second treatment step will be neutralization. The resultant sludge is filtered to separate the water from the solid precipitate. For better results the waste water subject to a first treatment step of basification is neutralized, then the P^{H} is extended up to an acid P^{H}, and then neutralized; similarly the waste water subjected to a first treatment step of acidification is neutralized, then the P^{H} is extended up to a basic P^{H}, and then neutralized.

Water discharged from a sewage treatment plant following conventional treatment may contain heavy metals, algae, fungi, micro-organisms of pathogens, nutrients like phosphorous, nitrogen, ammonia and other. The process of the present invention removes these chemicals or compositions, prevents pollution of the rivers, lakes and streams receiving the water, and prevents drinking water pollution by the water discharged from the sewage treatment plant.

The present invention provides a streamlined, simplified process that purifies water quickly and simply. The method of the invention reduces energy (electricity) consumption and is economical. The invention reduces the need for construction of expensive treatment plants and provides a process that is completed within hours and is not based on microbial activity. The invention also minimizes the need for multiple processes for the treatment of different sewage water compositions and facilitates recovery of chemicals used in or generated by the process. The treatment process removes pathogens, heavy metals, and suspended and dissolved solids. Nutrients like phosphorous, nitrogen, and ammonia are effectively removed. Water released from sewage treatment plants using the method of the present invention can be safely used for fish cropping, irrigation, gardening, lake maintenance, stream maintenance and for other uses.

### BRIEF DESCRIPTION OF THE DRAWINGS

FIG. 1 is a flow chart illustrating the acidification step in the sewage treatment process.

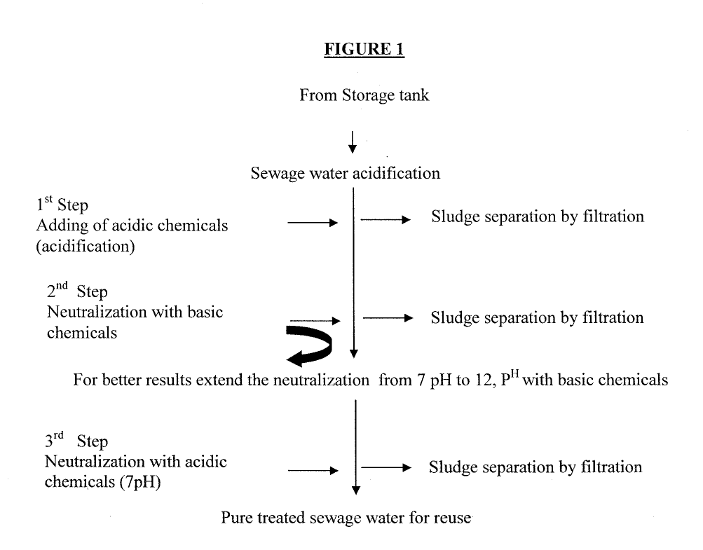

FIG. 2 is a flow chart of the basification step of the sewage treatment process.

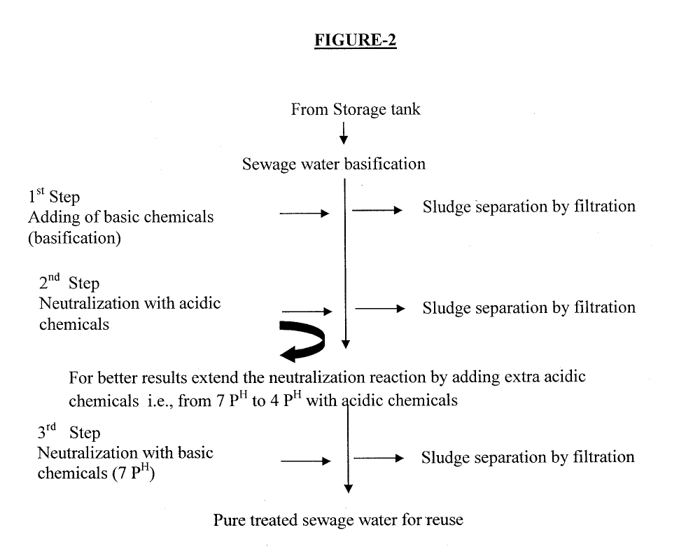

FIG. 3 is a flow chart showing recovery of chemicals from sludge resulting from the acidification and basification steps.

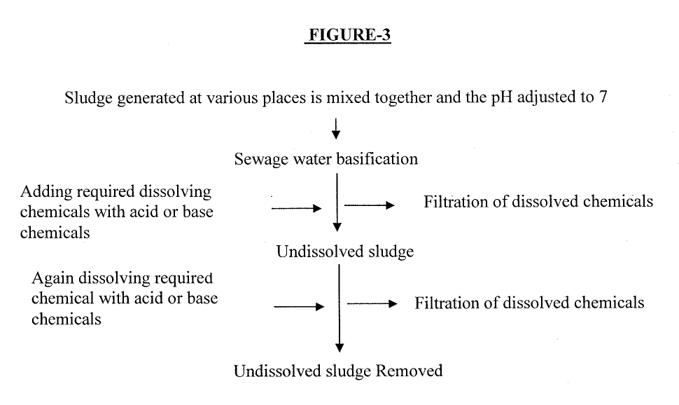

### DETAILED DESCRIPTION OF THE INVENTION

The process of sewage water treatment involves basification or acidification processes followed by neutralization, depending upon the composition of the sewage water. The impurities present in the sewage water are precipitated by the chemicals as described herein, to form a sludge which is treated separately. In this process either a batch or continuous process is possible.

The process of treating sewage water includes the steps of adding to a vessel, a known quantity of sewage water that is a mixture of raw sewage and water, and then adding one of:
basic chemical(s) selected from at least one of barium oxide, barium hydroxide, barium peroxide, barium sulfide, calcium oxide, calcium peroxide, calcium sulfide, and calcium hydroxide to obtain a basified composition with a pH of 12; and
acidic chemical(s) selected from at least one of at least one of oxalic acid, sulfuric acid, hydrofluoric acid, phosphoric acid, aluminum sulfate, ferrous sulfate, ferric sulfate, aluminum chloride, ferrous, chloride, and ferric chloride to obtain an acidified composition with a pH of 4.

Following acidification or basification, a precipitate containing solids is formed. The solid precipitate is removed, leaving in the case of the addition of basic chemical(s), the basified water that is formed, and in the case of the addition of acidic chemical(s), the acidified water that is formed.

The acidified or basified water is transferred to a separate vessel and a neutralizing agent is added to the basified or acidified water to obtain a pH of 7. For better results after an initial basification step, the sewage water is neutralized and then the P^{H} is extended to acid P^{H} by adding acidic chemical(s) followed by neutralization with basic chemical(s).

Similarly, for better results after an initial acidification step of the sewage water is neutralized then the P^{H} is extended to basic P^{H} by adding basic chemical(s) followed by neutralization with acidic chemical(s). Whether an initial process is basification or acidification is determined by the content of the sewage water.

Treatment of specific sewage water compositions is described in the following paragraphs.

### Acidification Process of Sewage Water Treatment

After preparatory treatment such as screening to remove large solids, a vessel such as a tank or reactor is filled with a measured volume of sewage water effluent, then based on analyzed content, a known quantity of at least one/many acidic chemical/s selected from oxalic acid, sulfuric acid, hydrofluoric acid, and phosphoric acid is added to the sewage water to obtain a pH of 4. The mixture is agitated for 30 min for proper mixing of the chemical/s with the sewage water. The reaction results precipitation of sludge containing suspended solids (TSS), including colloid particles, bacteria, viruses, phytoplankton and zooplankton, and metal chemicals such as metal sulfates, and traces of dissolved organic and inorganic solids. Ammonium compounds dissociate into nitrogen gas, the phosphorous forms aluminum phosphate, thus the sludge formed is separated from the semi-treated acidic sewage water and treated separately. The semi-treated acidic sewage water is transferred to a separate vessel for the second step of the treatment.

### Neutralization of Semi-Treated Acidic Sewage Water

After transferring the semi-treated acidic sewage water into the separate vessel, in a second treatment step at least one/many basic chemical/s is added, selected from barium oxide, barium hydroxide, barium peroxide, barium sulfide, calcium carbonate, calcium oxide, calcium peroxide, calcium sulfide, and calcium hydroxide up to 7. In this step of reaction, impurities are precipitated as sludge which is separated from the treated sewage water and treated separately.

The acidification or basification processes can follow this combination of chemical/s for the better results of TDS (total dissolved solids) reduction along all the parameters in the treated sewage water. The reduction in dissolved solids may be achieved by using at least one/many of basic chemical/s selected from barium oxide, barium hydroxide, barium peroxide, barium sulfide, calcium oxide, calcium peroxide, calcium sulfide, calcium hydroxide for the basification process and in the neutralization step using acidic chemical/s selected at least one/many of oxalic acid, sulfuric acid, hydrofluoric acid, and phosphoric acid.

The acidification or basification processes can follow this combination of chemical/s for the better results of TDS (total dissolved solids) reduction along all the parameters in the treated sewage water. The increase of trace of dissolved solids may be resulted by using at least one/many of basic chemicals selected from barium oxide, barium hydroxide, barium peroxide, barium sulfide, calcium oxide, calcium peroxide, calcium sulfide, calcium hydroxide in the basification step; and in the neutralization step using at least one/many of acidic chemicals selected from aluminum sulfate, ferrous sulfate, and ferric sulfate.

The acidification or basification processes will show an increase of dissolved solids due to using at least one of basic chemicals selected from barium oxide, barium hydroxide, barium peroxide, barium sulfide, calcium oxide, calcium peroxide, calcium sulfide, and calcium hydroxide in the basification step, and in the neutralization step, using at least one of acidic chemicals selected from aluminum chloride, ferrous chloride, ferric chloride, and hydrochloric acid.

High dissolved solids get increased by using at least one/many of basic chemicals selected from sodium oxide, sodium hydroxide, sodium peroxide, sodium sulfide, sodium silicate, sodium carbonate, sodium bi-carbonate, potassium oxide, potassium peroxide, potassium sulfide, potassium hydroxide, potassium carbonate, potassium bicarbonate, magnesium oxide, magnesium peroxide, magnesium sulfide, magnesium hydroxide, and magnesium carbonate in the basification step, and using at least one of acidic chemicals selected from aluminum chloride, ferrous chloride , ferric chloride, hydrochloric acid, sulfuric acid, and hydrofluoric acid in the neutralization step.

If the results are not good even after following the above chemical combinations then extend one more step in the acidification process that is for better results of acidification process of sewage water up to 4 P^{H} is done by adding acidic chemical(s) then neutralizing as usual by adding basic chemical(s) up to 7 P^{H} , and the neutralized stage is extended further by continuing further adding of more basic chemical(s) up to 12 P^{H} then again neutralizing by adding the acidic chemical(s) up to 7 P^{H}.

### Basification Process of Sewage Water Treatment

After preparatory screening treatment to remove large solids, a known volume of sewage water is added to a vessel such as a reactor or tank. The chemical content of the sewage water is analyzed, and, based on the analysis; a quantity of a basic chemical is added selected from at least one of barium oxide, barium hydroxide, barium peroxide, barium sulfide, calcium oxide, calcium peroxide, calcium sulfide, and calcium hydroxide to obtain a pH of 12. The mixture is stirred for about 30 min to adequately mix the chemical added. The basification reaction results in precipitation of total suspended solids (TSS), colloid particles, bacteria, viruses, phytoplankton and zooplankton, metal chemicals as metal hydroxides, and traces of dissolved organic and inorganic solids, Ammonium chemicals are formed and dissociate into ammonia gas. Calcium chloride, and/or ferrous chloride are added to the reaction to absorb the ammonia gas. Phosphorous precipitates as barium or calcium phosphate. Sludge formed is separated from the semi-treated basic sewage water and treated separately; the semi-treated basic sewage water obtained by basification is then transferred to a separate tank for the next step of neutralization.

### Neutralization of Semi-Treated Basic Sewage Water

After transferring the semi-treated basic sewage water from the basification tank to a separate tank, acidic chemical(s) are added as described in the following manner.

Acidic chemical(s) selected from at least one of oxalic acid, sulfuric acid, hydrofluoric acid, and phosphoric acid are added to the semi-treated basic sewage water up to 7 P^{H} to reduce total dissolved solids (TDS) and to optimize all the other parameters.

A combination of one or more acidic chemicals, selected from aluminum sulfate, ferrous sulfate, and ferric sulfate are added to the semi-treated basic sewage water resulting in trace of total dissolved solids (TDS) followed by neutralization in this second reaction step.

A combination of any one of acidic chemicals, selected from aluminum chloride, ferrous chloride, ferric chloride, and hydrochloric acid are added to the semi-treated basic sewage water to increase the quantity of total dissolved solids (TDS) in neutralization of the second reaction. Adding of any one or more of the above mentioned acidic chemical combinations for the neutralization of semi-treated basic sewage water results in precipitation of remaining impurities as sludge which is separated from the treated sewage water.

For better results basification process of sewage water up to 12 P^{H} is done by adding basic chemical(s) selected from at least one of barium oxide, barium hydroxide, barium peroxide, barium sulfide, calcium oxide, calcium peroxide, calcium sulfide, and calcium hydroxide, then neutralizing as usual by adding of acidic chemical(s) up to 7 P^{H}, but the neutralized stage is extended further by continuing further adding of more acidic chemical(s) up to 4 P^{H}, then again neutralizing it by adding the basic chemical(s) up to 7 P^{H}.

### Sludge Treatment

The sludge formed in basification and acidification reactions, is transferred to the sludge digestion bio gas plant where it is neutralized and then fed to the bio-gas digester for bio-gas synthesis. Generally the biogas contains methane 50-75%, carbon dioxide 25-50%, nitrogen 0-10%, hydrogen 0-1%, hydrogen sulfide 0-3%, and oxygen 0-2%. All gases except methane are absorbed by basic chemical solutions at a pH of 12. Mercaptan indole, skatole, and ammonia are removed by an acidic solution at treatment at a pH of 4.

### Reaction Mechanism of Acidification

When trivalent, bivalent coagulant, or acidic chemicals are added to sewage water, waste water or semi-treated sewage water or waste water it undergoes a series of hydrolysis reactions and forms flocks which get attached with suspended particles.

When alum (Aluminum sulfate) is added to any water it under goes a series of hydrolysis reactions as

Al(H₂O₆)₆³⁺+(aq)+H₂O→Al(H₂O)₅(OH)²⁺(aq)+H₃O⁺(aq) 1

Al(H₂O)₅(OH)²⁺+H₂O→Al(H₂O)₄(OH)₂⁺(aq)+H₃O⁺(aq) 2

Al(H₂O)₄(OH)₂⁺(aq)+H₂O→Al(H₂O)₃(OH)₃⁺(S)+H₃O⁺(aq) 3

Al(H₂O)₃(OH)₃⁺(s)+H₂O→Al(H₂O)₂(OH)₄⁻(aq)+H₃O⁺(aq) 4

The hydrolysis reactions involve successive deprotonation of the water of hydration surrounding the central metal ion. The extent of reactions depends on solution conditions, particularly the availability of Bronsted bases to act as proton acceptors for the released HO₃⁺ ion. The sewage water with pH ranges from 6.5 to 7.5 (alkaline) is mostly due to HCO₃⁻ ion.

Al(H₂O)₆³⁺(aq)+3HCO₃⁻(aq)→Al(OH)₃(S)+3CO₂+6H₂O 5

The positive polyvalent metal (Al₃⁺) ions collide with the negatively charged colloidal particles of the small size precipitate and also absorb the phosphate on the active surface of the freshly precipitated flock. A possible reaction involves the displacement of OH⁻ ions by the partially protonated phosphate species. Initially it reacts with phosphate and precipitate as insoluble aluminum phosphate.

Al³⁺(aq)+PO₄³(aq)→AlPO₄(aq) 6

Further the phosphate migrates to the interior part of the aluminum colloid and adsorb more phosphate, thus it continuously forms aluminum hydroxyl phosphate or aluminum phosphate.

Al(OH)₃+HPO₄²(aq)+H₂O→AlOH(HPO₄).H₂O(S)+2OH⁻(aq) 7

FeCl₃ or Ca(OH)₂ may be used as coagulants in place of alum, the Fe(III) species behave like Al(III), i.e. hydrolysis, reaction with phosphate, simultaneous removal of suspended materials but it is acidic in aqueous solution. Further it increases TDS, but Ca(OH)₂ precipitates the phosphate and also removes ammonia and nitrogen.

5Ca(OH)₂(aq)+3HPO₄²⁻(aq)→Ca₅OH(PO₄)₃(S)+6OH⁻(aq)+3H₂O NH₄⁺(aq)+OH⁻(aq)→NH₃(g)+H₂O 8

Ammonia gas that is formed escapes with external blown air or chlorination, for example by addition of hypochlorous acid, which removes ammonia by forming mono-di and tri-chloroamine.

NH₄⁺(aq)+HOCl(aq)→NH₂Cl(aq)+H₃O⁺(aq) 9

NH₂Cl(aq)+HOCl(aq)→NHCl₂(aq)+H₂O 10

NHCl₂(aq)+HOCl(aq)→NCl₃(aq)+H₂O 11

In presence of carbon adsorption filters the chloramines undergo a heterogeneous surface reaction which produces N₂ gas as one of the products in treatment. Lime may be added to facilitate the precipitation but acidification of the raw sewage to a P^{H} of 4 resulting in hydrolysis of Al₂ (SO₄)₃ and forms many structures based on pH condition.

$$\begin{matrix}\begin{matrix}{{Al}_{2} ( {SO}_{4} )}_{3} \\ ↑ ↓\end{matrix} \\ \begin{matrix}{[ {Al ( {H}_{2} O )}_{5} ( OH ) ]}^{2 +} \\ ↑ ↓ \\ [ {Al ( {H}_{2} O )}_{4} {( OH )}_{2}^{+} ]\end{matrix} \} {p}^{H} less than 4 \\ \begin{matrix}↑ ↓ & & \\ [ {{Al}_{6} ( {OH}_{15} ]}^{3 +} & {[ {{Al}_{8} ( OH )}_{20} ]}^{4 +} & at pH 4 to 5\end{matrix} \\ \begin{matrix}↑ ↓ \\ [ {Al ( {H}_{2} O )}_{3} {( OH )}_{3} ] at pH 5.5\end{matrix} \\ ↑ ↓ \\ \begin{matrix}{[ {{Al}_{2} ( OH )}_{7} ]}^{-} \\ ↑ ↓ \\ {[ {Al ( OH )}_{4} ]}^{-}\end{matrix} \} at pH greater than 7 & 12\end{matrix}$$

Of all hydrolysis products, the most important are the co-ordination chemicals with 6 and 8 atoms are reactively positive charged structures with neutral particles (Al₂(OH)₅Cl) and promote coagulation in natural water. The hydrolyzed hydroxide being positively charged ions attach to the negatively charged colloidal particles and suspended and dissolved organic matter. Thus it is precipitated at various levels of P^{H} conditions. The negatively charged ion SO⁻²₄ will dissolve the cation/s and exists in dissolved sulfate form as below.

### Detergents

2C₁₇H₃₅COONa+H₂SO₄→Na₂SO₄+2C₁₇H₃₅COOH 13

C₁₅H₃₀+H₂SO₄→C₁₅H₃₁SO₄H—or C₁₅H₃₂SO₄ 14

Alkalinity—Al(H₂O)₆³⁺(aq)+3HCO₃⁻(aq)→Al(OH)₃(S)+3CO₂+6H₂O 15

phosphate—Al³⁺(aq)+PO₄³(aq)→AlPO₄(aq) 16

Al(OH)₃+HPO₄²(aq)+H₂O→AlOH(HPO₄).H₂O(S)+2OH⁻(aq) 17

Nitrites—XNO₂→H₂SO₄+H₂NO₂+XSO₄↓ 18

H₂NO₂→H₂O+NO gass↑ 19

Nitrates XNO₃+H₂SO₄→H₂NO₃+XSO₄↓ 20

H₂NO₂→H₂O+NO gass↑ 21

Ammonia NH₃+H₂O→NH₄OH+H₂SO₄→NH₄SO₄+H₂O 22

Sulfur chemicals—XS+HSO₄=XSO₄+H₂S gass↑ 23

During treatment fats, proteins and oils are reacted. The fats have long hydrocarbon chains such chemicals are insoluble in water, but they form amalgams with amphoteric aluminum hydroxide at P^{H} 4. Metal salts can be used at low concentrations to precipitate enzymes and nucleic acids solutions Polyvalent metal ions frequently used are Ca²⁺, Mg²⁺, Mn²⁺ or Fe²⁺.

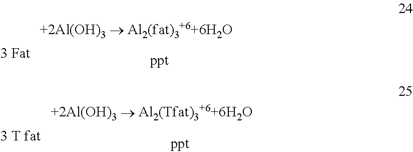

The oils in the water get break down and form flocks at P^{H} 4 and float on water.

Triolein (oil)3Oil+2Al(OH)₃→Al₂(Oil)₃⁺⁶+6H₂O 26

The oils in the water break down and form flocs at a pH of 4 to 5 and float on water due to reaction with aluminum hydroxide but the oil can be recovered just by adding sulphuric acid to precipitate.

α-Amino acid—Al2(Oil)⁺⁶₃+3HSO₄→Oil+Al₂(SO₄)₃ 27

Amino acids of

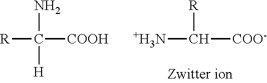

Biological components in the sewage water contain organic chemicals including amino acid carboxyl groups, and therefore possess both acidic and basic properties. All of the 22 amino acids found in proteins are S-amino acids. When the amino group is present with S-carbon atom, in general they are readily soluble in aqueous media and exist in neutral solutions as double charged ions known as Zwitter ions, and not as un-ionized molecules.

Such chemicals also react with the dissolved complex condition of the Al₂(SO₄)₃ because of having either of the charges and also an amphoteric molecule Al(OH)₃ complex 6 & 8 atom structure at P^{H} 4, where the dissolution structure at the pH of 4 is more active.

However the dissolution of

Al₂(SO₄)₄+3H₂O→2Al⁺(OH)₃⁻+3H₂^{+SO}₄⁻ 28

either dissolves at an acid pH or is precipitated by the amphoteric hydroxide. However even at P^{H} 7 proteins are usually negatively charged and therefore are precipitated, and an excess of the metal ion precipitates the proteins.

(NH₂)₂CO+HO₂→2NH₃+CO₂ 29

In addition the microorganisms, pathogenic and nonpathogenic bacteria, viruses, fungi, protozoa, algae and zooplankton are precipitated due to various cytoplasmic changes and enzymes interfering with biological activity. The vigorous stirring facilitates releasing most of the gases from liquid. Further the ionic chemicals like Na⁺ Cl⁺ K, Ca HCO₃ are converted into possible Na₂SO₄, KSO₄, Cl₂↑, and CO₂ respectively, due to acidification by sulfate molecules, however insoluble sludge settles at the bottom in the form of sulfates of Sb₂ (SO₄)₃; BaSO₄; Ca SO₄; Pb SO₄; Hg SO₄; Ag SO₄; AgSO4; RaSO₄; and

Ti₂(SO₄)₃ and AsH₃ (SO)₄+Ba(OH)₂,Ca(OH)₂—→AlAs, Ca₃(AsO₄)₂ or CaAsO₃H+H₂SO₄ 30

Removal of TDS using calcium fluoride in acidic conditions of the treatment process precipitates fluoride sludge as arsenic fluoride; calcium fluoride; chromium fluoride; cobalt fluoride; cobaltic hydroxide; magnesium fluoride; manganese fluoride; selenium fluoride; strontium fluoride; thallium sulfide; stannous fluoride; titanium fluoride; radium fluoride; and zinc fluoride. If acidity results it will be neutralized with basic chemicals.

### Reaction Mechanism of Basification

After preparatory screening treatment a known quantity of sewage waste water is filled into a vessel such as a reactor or tank. A known quantity of basic chemical(s), selected from at least one of barium carbonate, barium oxide, barium hydroxide, barium peroxide, barium sulfide, calcium carbonate, calcium oxide, calcium peroxide, calcium sulfide, calcium hydroxide is added to obtain a pH of 12, and the mixture is stirred for about 30 minutes to achieve proper mixing of the added chemicals. Total suspended solids (TSS) precipitate along with colloid particles formed by destabilization with calcium, barium, metal ions, micro-organisms, including bacteria, viruses, phytoplankton and zooplankton which are killed at the high pH of 12 or 14, metal chemicals such as metal hydroxides, and ammonium chemicals. Dissolved organic and inorganic solids are precipitated and the sludge formed is separated from the basified water. Calcium chloride, and/or ferrous chloride is added to the liquid along with the added basic chemical, under vigorous stirring to remove ammonia gas from the basic liquid.

NH₄SO₄+Ca(OH)₂→CaSO₄+NH₃↑+2H₂O 31

At 7 pH NH₄SO₄+CaSO₄→CaSO₄NH₄SO₄↓ 32

H₂SO₄+CO(OH)₂→CaSO₄↓+2H₂O

The basic liquid is then neutralized (pH 7pH) with acidic chemicals for the removal of metal (Fe, Cd, Co, Cr, Cu, Mn, Ni, Zn) contents. The dissolved sulfates are precipitated by displacement reaction and formation of hydroxides at various pH levels shown below.

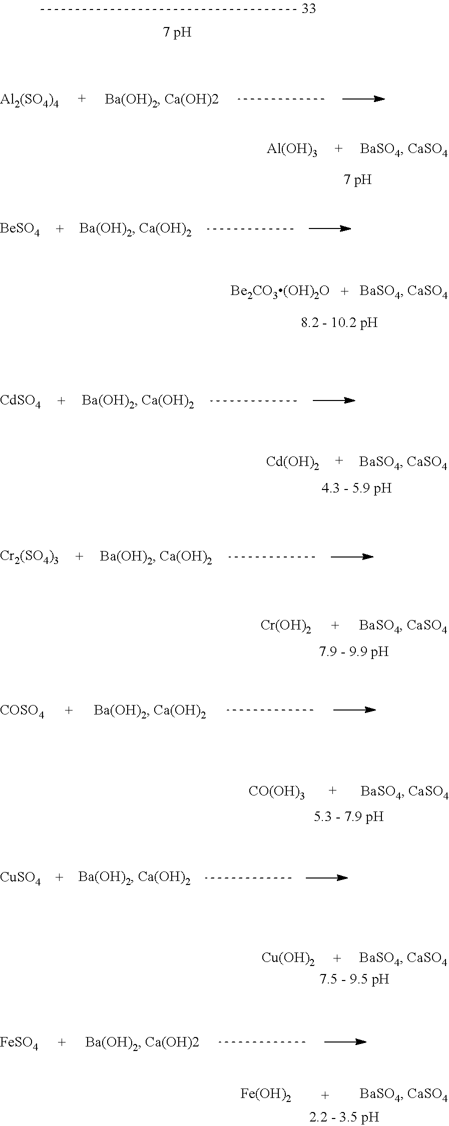

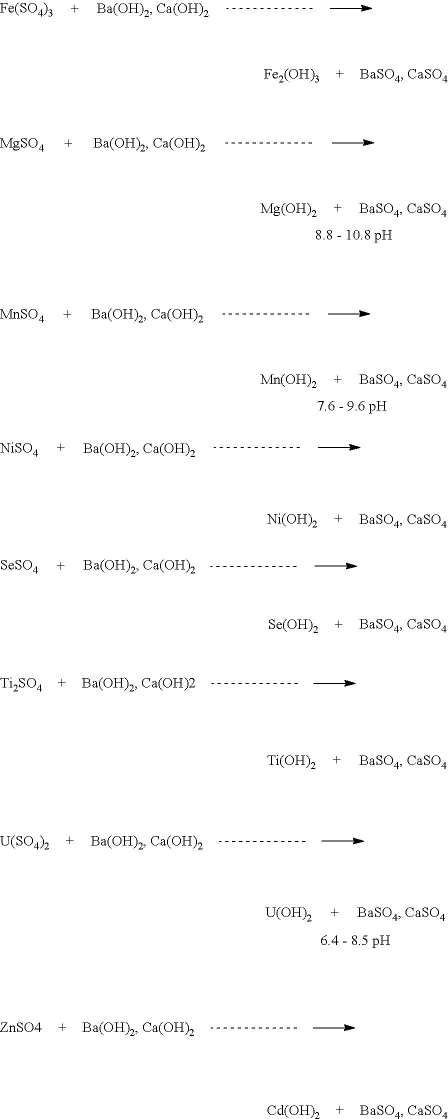

The sludge is removed by filtration from the basic liquid and then the liquid is neutralized with acidic chemicals up to 7 pH, and the sludge resulting from the reaction is filtered, and purified water is obtained.

It is seen that at a pH of 6 copper has a solubility of 20 mg/l and at a pH of 8.0, the solubility is 0.05 mg/l. Nickel at a pH of 8.0 nickel has a solubility of 70 mg/l and at a pH of 10.2 the solubility is 0.1 mg/l. Chromium and zinc are amphoteric, being soluble at both alkaline and acid conditions. Chromium reaches its least theoretical solubility of 0.08 at pH of 7.5. If both chromium and nickel are present a pH value that precipitates both ions must be chosen. It is common to utilize a pH of 9.0-9.5 to precipitate both metals. Ferric chloride and/or aluminum sulfate are generally used to accelerate the coagulation and precipitation of the heavy metals. Ferric hydroxide and/or aluminum hydroxide precipitate and tend to form co-precipitate with nickel and chromium. The effluent limitations for chromium and nickel are both 2.4 mg/l to discharge to a city sewer in the U.S. A pH value of 9-9.5 will usually precipitate both ions to their required level. If chromium must be precipitated to a level less than 0.5 mg/l the pH must be operated at pH 7.0-8.0. If nickel is present it must be precipitated with sulfide as the metallic sulfide ion. Chromium must be precipitated as the hydroxide at pH 7.0-8.0. The sulfide solubility is several orders of magnitude lower than the comparable hydroxides.

### Removal of Ammonia Complexes

Most heavy metal ions readily precipitate by raising the pH of solution, forming the respective metal hydroxide chemicals. Certain metal ions, primarily copper, zinc and cadmium readily form metallic complexes with ammonia. The ammonia metal complexes remain vary soluble at the higher pH values prohibiting the precipitation of the respective metal hydroxide. There are several methods conventionally used to destroy the ammonia complexes and precipitate the metallic ion. The ammonia ion may be destroyed by oxidation with chlorine or ozone. Eliminating the ammonia destroys the complex. However, the cost is prohibitive when compared to other methods. The addition of soluble ferrous ion as either ferrous sulfate or ferrous chloride will co-precipitate the metallic ion with the iron hydroxide, and is a more economical option.

The most economical method for ammonia removal is to add soluble sulfide ions and break the ammonia complex by precipitating the metallic sulfide chemicals. Copper sulfide, for example, is a very insoluble chemical and the presences of soluble sulfide precipitates the copper as it dissociates from the ammonia complex. Ultimately, the copper is all removed from the complex and precipitated as copper sulfide. The ammonia remains in the solution. Sulfide precipitation may be accomplished with inorganic sulfide or several sulfide rich organic chemicals.

In the basification treatment process of sewage /waste water adding barium sulfide and/or calcium sulfide further reduce TDS by the precipitation of Ags, Sb₂S₃, AsS, As₂S₃, BeS, B₂S₃, CdS, Cr2S3, CoS, CuS, FeS, MgS (decompose in to Mg(OH₂)) MnS, KS, SeS, TiS₂,Tl₂S, Sn2S, RaS, PbS, HgS, NiS, and V₂S₃ as sulfides. The sulfide sludge is removed along with together with sludge from basification and treated separately.

### EXAMPLE

Sewage water is added to a tank, and then acidic chemical (aluminum sulfate 1:2% dilution with water) is added to the sewage water, with stirring, until the P^{H} reaches acidic reaction of a P^{H} of from 5.5 to 4.0. The mixture is allowed to settle for 30 minutes and sludge settles to the bottom.

After 30 minutes, basic chemical (calcium hydroxide always in wet form that is 1:3% dilution) is added to the separated acidic sewage water, until basic reaction reaches P^{H} 7.5 to 8.0. The mixture is stirred well and allowed to settle for 30 min, where sludge settles to the bottom.

Water is removed from the tank and the settled sludge is shifted to a sand filter bed for drying.

If acidic P^{H} reaches more than 4.0, basic chemical is added until the P^{H} reaches from 7.5 to 8.0.
If basic P^{H} reaches more than 8.0, acidic chemical is added until the P^{H} reaches from 7.5 to 8.0.

A sample of raw sewage water sample used in the example was analyzed before treatment and then following treatment, the treated sewage water from the same sample was analyzed at an EPA certified laboratory.**

When dissolved solids are less than 5000 ppm then there is no microbial or heavy metal content.
At the end of treatment total dissolved solids were less than 5000 ppm, as shown in Table 1.

### Equipment Utilized

A) Total Dissolved Solids meter

B) P^{H} meter—digital—Extech PH100 Exstik Waterproof Pocket pH Tester

C) P^{H} paper 4 to 10 P^{H}—Extech EC400 conductivity/TDS/salinity tester

TABLE 1
RESULTS OF TREATMENT FROM EXAMPLE
Content of Treated Water Compared to 2006 WHO Guidelines

| | | Normally found in | | | |
|---|---|---|---|---|---|
| | | fresh water/surface | | Health based | |
| Element/ | Symbol/ | water/ground | | guideline by the | |
| substance | formula | water | | WHO 2006* | INVENTION** |
| Aluminum | Al | | | 0.2 mg/l | 0.000 mg/l |
| Ammonia | NH₄ | <0.2 | mg/l (up to | No guideline | 0.000 mg/l |
| | | | 0.3 mg/l in | | |
| | | | anaerobic | | |
| | | | waters) | | |
| Antimony | Sb | <4 | μg/l | 0.02 mg/l | 0.00 mg/l |
| Arsenic | As | | | 0.01 mg/l | 0.000 mg/l |
| Asbestos | | | | No guideline | 0.00 mg/l |
| Barium | Ba | | | 0.7 mg/l | 0.4 mg/l |
| Berillium | Be | <1 | μg/l | No guideline | No guideline |
| Boron | B | <1 | mg/l | 0.5 mg/l | 0.000 mg/l |
| Cadmium | Cd | <1 | μg/l | 0.003 mg/l | 0.000 mg/l |
| Chloride | Cl | | | No guideline | No guideline |
| Chromium | Cr⁺³, Cr⁺⁶ | <2 | μg/l | 0.05 mg/l | 0.000 mg/l |
| Colour | | | | Not mentioned | Not mentioned |
| Copper | Cu | | | 2 mg/l | 000 mg/l |
| Cyanide | CN⁻ | | | 0.07 mg/l | 0.000 mg/l |
| Dissolved | O₂ | | | No guideline | 4 mg/L |
| oxygen | | | | | |
| Fluoride | F | <1.5 | mg/l | 1.5 mg/l | 0.000 mg/l |
| | | | (up to 10) | | |
| Hardness | mg/l CaCO₃ | | | No guideline | 100 to 200 |
| Hydrogen | H₂S | | | No guideline | 0.000 mg/L |
| sulfide | | | | | |
| Iron | Fe | 0.5-50 | mg/l | No guideline | 0.000 mg/L |
| Lead | Pb | | | 0.01 mg/l | 0.000 mg/L |
| Manganese | Mn | | | 0.4 mg/l | 0.2 mg/l |
| Mercury | Hg | <0.5 | μg/l | 0.006 mg/l | 0.000 mg/L |
| Molybdenum | Mb | <0.01 | mg/l | 0.07 mg/l | 0.000 mg/L |
| Nickel | Ni | <0.02 | mg/l | 0.07 mg/l | 0.000 mg/L |
| Nitrate and | NO₃, NO₂ | | | 50 mg/l and | 8 mg/l and |
| nitrite | | | | 3 mg/l | 16 mg/l |
| Turbidity | | | | Not mentioned | 3 |
| pH | | | | No guideline | 7.5 |
| Selenium | Se | <<0.01 | mg/l | 0.01 mg/l | 0.000 mg/L |
| Silver | Ag | 5-50 | μg/l | No guideline | 0.000 mg/L |
| Sodium | Na | <20 | mg/l | No guideline | Not treated |
| Sulfate | SO₄ | | | No guideline | Not treated |
| Inorganic tin | Sn | | | Not mentioned | 0.000 mg/L |
| TDS | | | | No guideline | 300 mg/L |
| Uranium | U | | | 0.015 mg/l | 0.000 mg/L |
| Zinc | Zn | | | No guideline | 0.000 mg/L |

*WHO Library Cataloguing-in-Publication Data World Health Organization. Guidelines for drinking-water quality [electronic resource]: incorporating first addendum. Vol. 1, Recommendations. - 3rd ed. Electronic version for the Web. 1. Potable water - standards. 2. Water - standards. 3. Water quality - standards. 4. Guidelines. I. Title. ISBN 92 4 154696 4 (NLM classification: WA 675
**Raw sewer water and treated water were analyzed at an EPA certified lab, Bhagavathi Ana Labs Limited, Central Laboratory, Plot No. 7-2-C& &8/4, Industrial Estate, Sanathnagar, Hyderabad-500018, India. http:/bhagavathianalabs.com

What is claimed is:

1. A process of treating sewage water, comprising the steps of:
a) in a vessel with a known quantity of sewage water that is a mixture of raw sewage and water, adding one of:
basic chemical selected from at least one of barium oxide, barium hydroxide, barium peroxide, barium sulfide, calcium oxide, calcium peroxide, calcium sulfide, and calcium hydroxide to obtain a basified composition with a pH of 12; and
acidic chemical selected from at least one of oxalic acid, sulfuric acid, hydrofluoric acid, phosphoric acid, aluminum sulfate, ferrous sulfate, ferric sulfate, aluminum chloride, ferrous, chloride, and ferric chloride to obtain an acidified composition with a pH of 4,
whereby a precipitate formed with either the addition of basic chemical or acidic chemical, and in the case of the additional of basic chemical basic water is formed, and in the case of addition of acidic chemical acidic water is formed;
b) separating the precipitate from acidic water or basic water and transferring the water to a separate vessel;
c) adding a neutralizing agent to the basic or acidic water obtained in step b), to obtain a pH of from 7 to 8;
d) separating precipitate from treated water obtained in the neutralization step;
e) recovering chemicals used in the treatment processes;
whereby purified water containing no microbial content of Escherichia coli, enterococci, pseudomonas, aeruginosa, clostridium perfringens, and coliform is obtained.

2. The process of claim 1, wherein step a) comprises selecting acidic chemical and step b) comprises selecting basic chemical.

3. The process of claim 1 wherein step a) comprises selecting a basic chemical, and step b) comprises selecting acidic chemical.

4. The process of claim 1 wherein step b) comprises the addition of acidic chemical selected from at least one of oxalic acid, sulfuric acid, and hydrofluoric acid; and the subsequent neutralization step comprises the addition of a basic chemical selected from at least one of barium carbonate, barium oxide, barium hydroxide, barium peroxide, calcium carbonate, calcium oxide, calcium peroxide, and calcium hydroxide.

5. The process of claim 1 wherein step b) includes the addition of acidic chemical selected from at least one of aluminum sulfate, ferrous sulfate, and ferric sulfate, resulting in the reduction of the quantity of total dissolved solids.

6. The process of claim 1 wherein step b) includes the addition of acidic chemical selected from at least one of aluminum chloride, ferrous chloride, ferric chloride, and hydrochloric acid, and the subsequent neutralization step includes the addition of basic chemical selected from at least one of barium oxide, barium hydroxide, barium peroxide, calcium carbonate, calcium oxide, calcium peroxide, and calcium hydroxide resulting in the increase of the quantity of total dissolved solids.

7. The process of claim 1, wherein in step a) comprises the addition of acidic chemical selected from at least one of oxalic acid, sulfuric acid, hydrofluoric acid, and phosphoric acid and the resulting acidified water is neutralized with basic chemical selected from at least one of barium carbonate, barium oxide, barium hydroxide, barium peroxide, calcium carbonate, calcium oxide, calcium peroxide and calcium hydroxide.

8. The process of claim 1, wherein step a) includes the addition of acidic chemical selected from at least one of aluminum sulfate, ferrous sulfate and ferric sulfate, and the resulting acidified water is neutralized with the addition of basic chemical selected from at least one of barium oxide, barium hydroxide, barium peroxide, calcium carbonate, calcium oxide, calcium peroxide, and calcium hydroxide.

9. The process of claim 1, wherein step a) includes the addition of acidic chemical selected from at least one of aluminum chloride, ferrous chloride, ferric chloride, aluminum sulfate, ferrous sulfate, and ferric sulfate, and the resulting acidified water is neutralized with the addition of basic chemical selected from at least one of barium oxide, barium hydroxide, barium peroxide, barium sulfide, calcium carbonate, calcium oxide, calcium peroxide, calcium sulfide, and calcium hydroxide.

10. The process of claim 1, wherein step a) includes the addition of acidic chemical selected from at least one of aluminum chloride, ferrous chloride, ferric chloride, oxalic acid, sulfuric acid, hydrofluoric acid, and phosphoric acid and the resulting acidified water is neutralized with the addition of basic chemical selected from at least one of sodium oxide, sodium hydroxide, sodium peroxide, sodium silicate, sodium carbonate, sodium bi-carbonate, potassium oxide, potassium peroxide, potassium hydroxide, potassium carbonate, potassium bicarbonate, magnesium oxide, magnesium peroxide, magnesium sulfide, magnesium hydroxide, magnesium carbonate, and magnesium hydroxide.

11. The process of claim 1 wherein step a) further comprises adding at least one of calcium chloride and ferrous chloride in steps a) and b), to the remove nitrogen and hydrogen sulfide produced during the acidification and basification reactions.

12. The process of claim 1 further comprising a step following neutralization step d) wherein further acid chemical is added to the treated water, followed by removal of the precipitate generated, followed by a further neutralization step of the acidified water.

13. The process of claim 1, further comprising the step of using sludge generated in step a) and step b) for biogas synthesis.

14. The process of claim 13, wherein the biogas generated is purified by passing it through one of basic and acidic chemical solutions for the removal of polluted gasses.

15. The process of claim 1, wherein chemicals are recovered from sludge generated in the acidification and basification steps by sludge digestion in one of an acid and a base.
